(19) United States
(12) Patent Application Publication
(10) Pub. No.: US 2024/0294166 A1
(43) Pub. Date: Sep. 5, 2024

(54) APPARATUS FOR DRIVING ASSISTANCE, VEHICLE INCLUDING THE SAME, AND METHOD FOR DRIVING ASSISTANCE

(71) Applicant: HL Klemove Corp., Incheon (KR)

(72) Inventor: Inyoung JUNG, Seongnam-si (KR)

(73) Assignee: HL Klemove Corp., Incheon (KR)

(21) Appl. No.: 18/229,852

(22) Filed: Aug. 3, 2023

(30) Foreign Application Priority Data
Mar. 3, 2023 (KR) 10-2023-0028250

(51) Int. Cl. B60W 30/12; B60W 10/20; B60W 40/105; G06V 20/56

(52) U.S. Cl. CPC B60W 30/12; B60W 10/20; B60W 40/105; G06V 20/588; B60W 2420/403; B60W 2510/202; B60W 2554/60; B60W 2554/802; B60W 2710/202

(57) ABSTRACT

An apparatus for driving assistance includes a camera mounted on a vehicle to have a field of view around the vehicle and configured to obtain image data and a controller configured to determine a control torque for performing a lane following assist function by processing the image data and behavior data obtained from a behavior sensor provided in the vehicle, identify a speed bump in a driving lane based on the image data, and maintain the control torque determined before passing the speed bump while the vehicle passes the speed bump.

### CROSS-REFERENCE TO RELATED APPLICATION

This application claims the benefit of Korean Patent Application No. 10-2023-0028250, filed on Mar. 3, 2023 in the Korean Intellectual Property Office, the disclosure of which is incorporated herein by reference.

### BACKGROUND

### 1. Field

Embodiments of the present disclosure relate to an apparatus for driving assistance to stably perform a lane following assist function, a vehicle including the same, and an method for driving assistance.

### 2. Description of the Related Art

In modern society, vehicles are the most common means of transportation, and the number of people using vehicles is ever-increasing. With the development of vehicle technologies, there are advantages such as facilitating traveling over long distances, making people's lives more convenient, and so on, but in densely populated places such as Korea, problems such as serious traffic congestion due to worsening road traffic conditions often occur.

In recent years, in order to relieve a driver's burden and increase his or her convenience, studies regarding vehicles equipped with an advanced driver assist system (ADAS) which actively provides information related to a state of a vehicle, a state of the driver, and surrounding conditions have been actively in progress.

An example of the ADAS mounted on the vehicle includes a lane departure warning (LDW) system, a lane following assist (LFA) system, a high beam assist (HBA) system, an autonomous emergency braking (AEB) system, a traffic sign recognition (TSR) system, an adaptive cruise control (ACC) system, or a blind spot detection (BSD) system.

### SUMMARY

Therefore, it is an aspect of the present disclosure to provide a driving assistance apparatus capable of stably performing a lane following control function even when a speed bump is passed during operation of the lane following control function, a vehicle including the same, and a driving assistance method.

Additional aspects of the disclosure will be set forth in part in the description which follows and, in part, will be obvious from the description, or may be learned by practice of the disclosure.

In accordance with one aspect of the present disclosure, a driving assistance apparatus includes a camera mounted on a vehicle to have a field of view around the vehicle and configured to obtain image data and a controller configured to determine a control torque for performing a lane following assist function based on processing the image data and behavior data obtained from a behavior sensor provided in the vehicle, identify a speed bump in a driving lane of the vehicle based on the processing of the image data, and maintain the control torque determined before passing the speed bump while the vehicle passes the speed bump.

The behavior data may include data on at least one of a steering angle, a steering speed, a yaw rate, or a wheel speed.

The controller may identify a distance to the speed bump based on the processing of the image data and the behavior data.

The controller may identify a time required to pass the speed bump based on the processing of the image data and the behavior data.

The controller may be configured to identify a width of the speed bump based on the processing of the image data, identify a speed of the vehicle based on the processing of the behavior data, and determine a time required to pass the speed bump based on the identified width of the speed bump and the identified speed of the vehicle.

The controller may maintain the control torque determined before passing the speed bump for the determined time.

The controller may transmit the control torque determined before passing the speed bump to a steering apparatus of the vehicle so that steering control according to the control torque determined before passing the speed bump is performed while the vehicle passes the speed bump.

In accordance with another aspect of the present disclosure, a driving assistance method includes obtaining image data through a camera having a field of view around a vehicle, determining a control torque for performing a lane following assist function based on processing the image data and behavior data obtained from a behavior sensor provided in the vehicle, identifying a speed bump in a driving lane of the vehicle based on the image data, and maintaining the control torque determined before passing the speed bump while the vehicle passes the speed bump.

The behavior data may include data on at least one of a steering angle, a steering speed, a yaw rate, or a wheel speed.

The driving assistance method may further include identifying a distance to the speed bump based on the processing of the image data and the behavior data.

The maintaining of the control torque determined before passing the speed bump while the vehicle passes the speed bump may include determining a time required to pass the speed bump based on the processing of the image data and the behavior data.

The maintaining of the control torque determined before passing the speed bump while the vehicle passes the speed bump may include identifying a width of the speed bump based on the processing of the image data, identifying a speed of the vehicle based on the processing of the behavior data, and determining a time required to pass the speed bump based on the identified width of the speed bump and the identified speed of the vehicle.

The maintaining of the control torque determined before passing the speed bump while the vehicle passes the speed bump may include maintaining the control torque determined before passing the speed bump for the determined time.

The driving assistance method may further include transmitting the control torque determined before passing the speed bump to a steering apparatus of the vehicle so that steering control according to the control torque determined before passing the speed bump is performed while the vehicle passes the speed bump.

In accordance with still another aspect of the present disclosure, a vehicle includes a camera having a field of view around the vehicle and configured to obtain image data, a behavior sensor configured to obtain behavior data of the vehicle, and a controller configured to determine a control torque for performing a lane following assist function based on processing the image data and the behavior data, identify a speed bump in a driving lane of the vehicle based on the processing of the image data, and maintain the control torque determined before passing the speed bump while the vehicle passes the speed bump.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates configurations of a vehicle and a driving assistance apparatus in accordance with one embodiment;

FIG. 2 illustrates fields of view of a camera, a radar, and a lidar included in the driving assistance apparatus in accordance with one embodiment;

FIG. 3 illustrates function modules of a controller included in the driving assistance apparatus in accordance with one embodiment;

FIG. 4 is a diagram embodying a control module illustrated in FIG. 3;

FIG. 5 illustrates a field of view of a camera of the vehicle;

FIG. 6 illustrates that the vehicle of the disclosed embodiment identifies a speed bump;

FIG. 7 illustrates a distance from the vehicle to the speed bump;

FIG. 8 illustrates a width of the speed bump; and

FIGS. 9 and 10 illustrate operations of the driving assistance apparatus in accordance with one embodiment.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

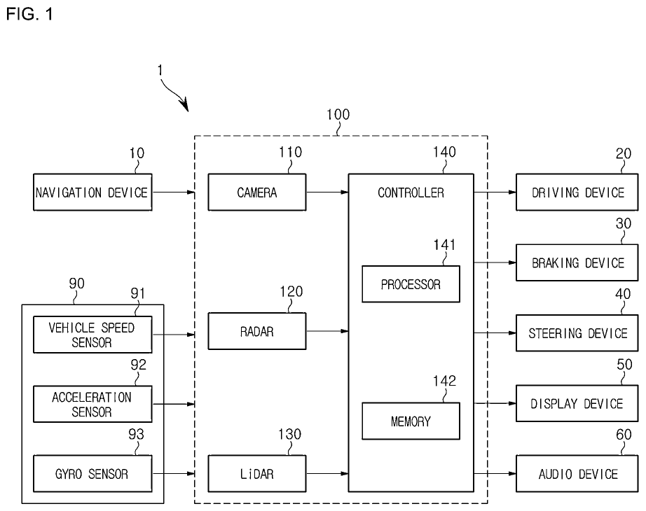

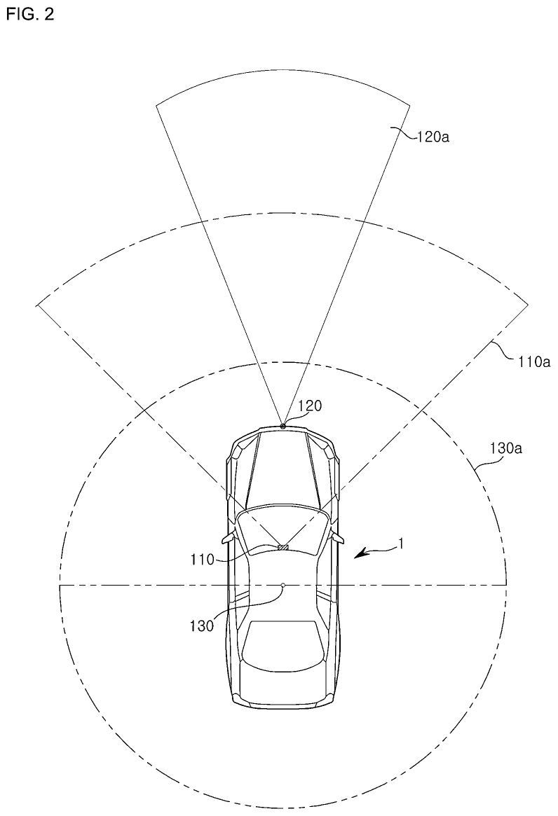

FIG. 1 illustrates a configuration of a vehicle in accordance with one embodiment. FIG. 2 illustrates fields of view of a camera, a radar, and a lidar included in a driving assistance apparatus in accordance with one embodiment.

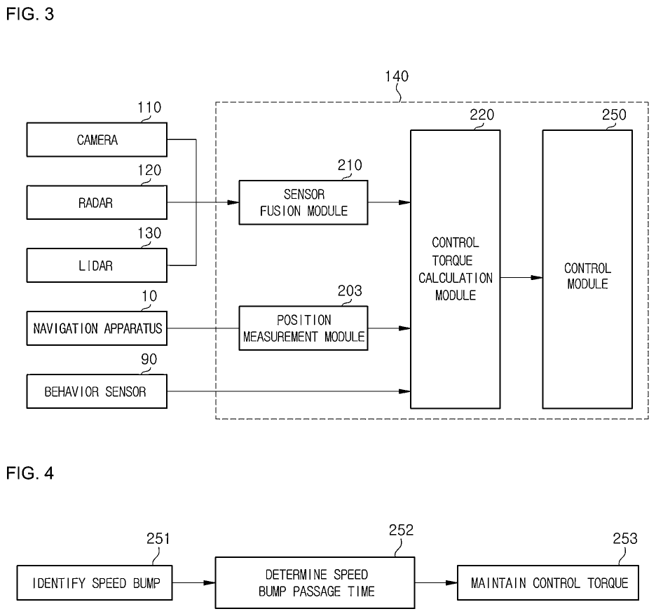

As illustrated in FIG. 1, a vehicle 1 may include a navigation apparatus 10, a driving apparatus 20, a braking apparatus 30, a steering apparatus 40, a display apparatus 50, an audio apparatus 60, and/or a driving assistance apparatus 100. In addition, the vehicle 1 may further include a behavior sensor 90 (see FIG. 3) that detects dynamics of the vehicle 1. For example, the behavior sensor 90 (see FIG. 3) may include a vehicle speed sensor 91 for detecting a longitudinal speed of the vehicle 1, an acceleration sensor 92 for detecting a longitudinal acceleration and a lateral acceleration of the vehicle 1, and/or a gyro sensor 93 for detecting a yaw rate, a roll rate, and a pitch rate of the vehicle 1.

These apparatuses and sensors may communicate with each other through a vehicle communication network (NT). For example, the electrical devices 10, 20, 30, 40, 50, 60, 91, 92, 93, and 100 included in the vehicle 1 may transmit and receive data through Ethernet, Media Oriented Systems Transport (MOST), FlexRay, Controller Area Network (CAN), Local Interconnect Network (LIN), or the like.

The navigation apparatus 10 may generate a route to a destination input by the driver and provide the generated route to the driver. The navigation apparatus 10 may receive a global navigation satellite system (GNSS) signal from a GNSS and identify an absolute position (coordinates) of the vehicle 1 based on the GNSS signal. The navigation apparatus 10 may generate a route to the destination based on the position (coordinates) of the destination input by the driver and the current position (coordinates) of the vehicle 1.

The navigation apparatus 10 may provide map data and position information for the vehicle 1 to the driving assistance apparatus 100. In addition, the navigation apparatus 10 may provide information on the route to the destination to the driving assistance apparatus 100. For example, the navigation apparatus 10 may provide information such as a distance to an access road for the vehicle 1 to enter a new road or a distance to an exit road for the vehicle 1 to exit from a road currently driving to the driving assistance apparatus 100.

The driving apparatus 20 may move the vehicle 1 and include, for example, an engine, an engine management system (EMS), a transmission, and a transmission control unit (TCU). The engine may generate power for driving the vehicle 1, and the engine management system may control the engine in response to a driver's willingness to accelerate through an accelerator pedal or a request from the driving assistance apparatus 100. The transmission may reduce the power generated by the engine and transfer the reduced power to the wheels, and the transmission control unit may control the transmission in response to a driver's shift command through a shift lever and/or a request from the driving assistance apparatus 100.

The braking apparatus 30 may stop the vehicle 1 and include, for example, a brake caliper and an electronic brake control module (EBCM). The brake caliper may decelerate the vehicle 1 or stop the vehicle 1 using friction with a brake disc, and the electronic brake control module may control the brake caliper in response to a driver's willingness to brake through a brake pedal and/or a request from the driving assistance apparatus 100. For example, the electronic brake control module may receive a deceleration request including a deceleration rate from the driving assistance apparatus 100 and electrically or hydraulically control the brake caliper so that the vehicle 1 decelerates depending on the requested deceleration rate.

The steering apparatus 40 may include an electronic power steering control module (EPS). The steering apparatus 40 may change a driving direction of the vehicle 1, and the electronic power steering control module may assist the operation of the steering apparatus 40 so that the driver may easily operate a steering wheel in response to a driver's willingness to steer through the steering wheel. Further, the electronic power steering control module may control the steering apparatus in response to a request from the driving assistance apparatus 100. For example, the electronic power steering control module may receive a steering request including steering torque from the driving assistance apparatus 100 and control the steering apparatus so that the vehicle 1 is steered depending on the requested steering torque.

The display apparatus 50 may include a cluster, a head-up display, a center fascia monitor, and the like, and may provide various information and entertainment to the driver through images and sounds. For example, the display apparatus 50 may provide driving information about the vehicle 1, a warning message, or the like, to the driver.

The audio apparatus 60 may include a plurality of speakers and provide various information and entertainment to the driver through sound. For example, the audio apparatus 60 may provide driving information about the vehicle 1, a warning message, or the like, to the driver.

The driving assistance apparatus 100 may communicate with the navigation apparatus 10, the behavior sensor 90, the driving apparatus 20, the braking apparatus 30, the steering apparatus 40, the display apparatus 50, and the audio apparatus 60 through the vehicle communication network. The driving assistance apparatus 100 may receive information on the route to the destination and position information about the vehicle 1 from the navigation apparatus 10, and obtain information about vehicle speed, acceleration and/or angular velocity of the vehicle 1 from the behavior sensor 90.

The driving assistance apparatus 100 may provide various functions for safety to the driver. For example, the driving assistance apparatus 100 may provide a lane departure warning (LDW) function, a lane following assist (LFA) function, a high beam assist (HBA) function, an autonomous emergency braking (AEB) function, a traffic sign recognition (TSR) function, an adaptive cruise control (ACC) function, a blind spot detection (BSD) function, or the like.

The driving assistance apparatus 100 may include a camera 110, a radar 120, a lidar 130, and a controller 140. The driving assistance apparatus 100 is not limited to that illustrated in FIG. 1. For example, in the driving assistance apparatus 100 illustrated in FIG. 1, at least one sensing device among the camera 110, the radar 120, and the lidar 130 may be omitted or various sensing devices capable of detecting surrounding objects of the vehicle 1 may be added.

The camera 110, the radar 120, the lidar 130, and the controller 140 may be provided separately from each other. For example, the controller 140 may be installed in a housing separated from a housing of the camera 110, a housing of the radar 120, and a housing of the lidar 130. The controller 140 may exchange data with the camera 110, the radar 120, or the lidar 130 through a wide-bandwidth network.

In addition, at least some of the camera 110, the radar 120, the lidar 130, and the controller 140 may be provided in an integrated form. For example, the camera 110 and the controller 140 may be provided in one housing, the radar 120 and the controller 140 may be provided in one housing, or the lidar 130 and the controller 140 may be provided in one housing.

The camera 110 may photograph surroundings of the vehicle 1 and obtain image data of the surroundings of the vehicle 1. For example, the camera 110 may be installed on a front windshield of the vehicle 1 as illustrated in FIG. 2 and may have a field of view 110a facing an area in front of the vehicle 1.

The camera 110 may include a plurality of lenses and an image sensor. The image sensor may include a plurality of photodiodes that convert light into electrical signals, and the plurality of photodiodes may be arranged in a two-dimensional matrix.

The image data may include information on other vehicles, pedestrians, cyclists, or lane lines (markers distinguishing lanes) positioned around the vehicle 1.

The driving assistance apparatus 100 may include an image processor that processes the image data of the camera 110, and the image processor may be provided integrally with the camera 110 or integrally with the controller 140, for example.

The image processor may obtain the image data from the image sensor of the camera 110 and detect and identify objects around the vehicle 1 based on processing of the image data. For example, the image processor may generate tracks representing the objects around the vehicle 1 using image processing, and classify the tracks. The image processor may identify whether a track is another vehicle, a pedestrian, a cyclist, or the like, and assign an identification code to the track.

The image processor may transfer data (or position and classification of the track) on a track around the vehicle 1 (hereinafter referred to as a “camera track”) to the controller 140.

The radar 120 may transmit transmission radio waves toward the surroundings of the vehicle 1 and detect objects around the vehicle 1 based on reflected radio waves reflected from the surrounding objects. For example, the radar 120 may be installed on a grille or bumper of the vehicle 1 as illustrated in FIG. 2 and have a field of sensing 120a facing an area in front of the vehicle 1.

The radar 120 may include a transmission antenna (or a transmission antenna array) for radiating transmission radio waves toward the surroundings of the vehicle 1 and a reception antenna (or a reception antenna array) for receiving radio waves reflected from an object.

The radar 120 may obtain radar data from the transmission radio waves transmitted by the transmission antenna and reflected radio waves received by the reception antenna. The radar data may include position information (e.g., distance information) and/or speed information about objects positioned in front of the vehicle 1.

The driving assistance apparatus 100 may include a signal processor that processes the radar data of the radar 120, and the signal processor may be provided integrally with the radar 120 or integrally with the controller 140, for example.

The signal processor may obtain the radar data from the reception antenna of the radar 120 and generate data on motion of an object by clustering reflection points of reflected signals. The signal processor may obtain a distance to the object based on, for example, a time difference between a transmission time of a transmission radio wave and a reception time of a reflected radio wave, and obtain speed of the object based on a difference between a frequency of the transmission radio wave and a frequency of the reflected radio wave.

The signal processor may transfer data on motion of the object around the vehicle 1 obtained from the radar data to the controller 140.

The lidar 130 may transmit light (e.g., infrared rays) toward the surroundings of the vehicle 1 and detect a surrounding object of the vehicle 1 based on reflection light reflected from the surrounding object. For example, the lidar 130 may be installed on a roof of the vehicle 1 as illustrated in FIG. 2 and have a field of view 130a in all directions around the vehicle 1.

The lidar 130 may include a light source (e.g., a light emitting diode, a light emitting diode array, a laser diode, or a laser diode array) emitting light (e.g., infrared rays), and an optical sensor (e.g., a photodiode or a photodiode array) that receives light (e.g., infrared rays). In addition, the lidar 130 may further include a driving apparatus for rotating the light source and/or the optical sensor as needed.

The lidar 130 may emit light through the light source and receive light reflected from the object through the light sensor while the light source and/or the light sensor rotates, thereby obtaining lidar data.

The lidar data may include relative positions (distances to and/or directions of surrounding objects) and/or relative speeds of the surrounding objects of the vehicle 1.

The driving assistance apparatus 100 may include a signal processor capable of processing the lidar data of the lidar 130, and the signal processor may be provided integrally with the lidar 130 or integrally with the controller 140, for example.

The signal processor may generate data on motion of an object by clustering reflection points by reflection light. The signal processor may obtain a distance to an object based on, for example, a time difference between a light transmission time and a light reception time. In addition, the signal processor may obtain a direction (or angle) of the object with respect to a driving direction of the vehicle 1 based on a direction in which the light source emits light when the optical sensor receives the reflection light.

The signal processor may transfer data on motion of the object around the vehicle 1 obtained from the lidar data to the controller 140.

The controller 140 may be electrically connected to the camera 110, the radar 120, and/or the lidar 130. In addition, the controller 140 may be connected to the navigation apparatus 10, the driving apparatus 20, the braking apparatus 30, the steering apparatus 40, the display apparatus 50, the audio apparatus 60, and/or the behavior sensor 90 through the vehicle communication network NT.

The controller 140 may process the image data of the camera 110, the radar data of the radar 120, and/or the lidar data of the lidar 130 and provide control signals to the driving apparatus 20, the braking apparatus 30, and/or the steering apparatus 40.

The controller 140 may include a processor 141 and a memory 142.

The memory 142 may store programs and/or data for processing the image data, the radar data, and/or the lidar data. Further, the memory 142 may store programs and/or data for generating driving/braking/steering signals.

The memory 142 may temporarily store the image data received from the camera 110, the radar data received from the radar 120, and/or the lidar data received from the lidar 130, and temporarily store processing results of the image data, the radar data, and/or the lidar data by the processor 141.

Further, the memory 142 may include a high-definition map (HD Map). Unlike general maps, the high-definition map may include detailed information about surfaces of roads or intersections such as lane lines, traffic lights, intersections, and road signs. In particular, in the high-definition map, landmarks (e.g., lane lines, traffic lights, intersections, and road signs) that a vehicle encounters while driving are implemented in 3D.

The memory 142 may include not only volatile memories such as a static random-access memory (S-RAM) and a dynamic random-access memory (D-RAM), but also non-volatile memories such as a flash memory, a read only memory (ROM), and an erasable programmable read only memory (EPROM).

The processor 141 may process the image data of the camera 110, the radar data of the radar 120, and/or the lidar data of the lidar 130. For example, the processor 141 may fuse the image data, the radar data, and/or the lidar data and output fusion data.

The processor 141 may generate a driving signal, a braking signal, and/or a steering signal for controlling the driving apparatus 20, the braking apparatus 30, and/or the steering apparatus 40, respectively, based on processing the fusion data. For example, the processor 141 may predict a collision with an object around the vehicle 1 using the fusion data and control the driving apparatus 20, the braking apparatus 30, and/or the steering apparatus 40 to steer or brake the vehicle 1 accordingly.

The processor 141 may include the image processor that processes the image data of the camera 110, the signal processor that processes the radar data of the radar 120 and/or the lidar data of the lidar 130, or a micro control unit (MCU) that generates driving/braking/steering signals.

As described above, the controller 140 may provide the driving signal, the braking signal, or the steering signal based on the image data of the camera 110, the radar data of the radar 120, or the lidar data of the lidar 130.

Meanwhile, when a speed bump 350 is passed while the lane following assist (LFA) function is operating, a control torque for the operation of the LFA function may be abnormally calculated due to misrecognition of the lane lines or unstable behavior of the vehicle. In this case, the vehicle may not maintain the lane line and may deviate from the lane line. The embodiment disclosed herein provides the driving assistance apparatus enabling the lane following assist function to stably operate while a vehicle passes the speed bump 350. Hereinafter, specific operations of the driving assistance apparatus 100 in accordance with the disclosed embodiment will be described in more detail below.

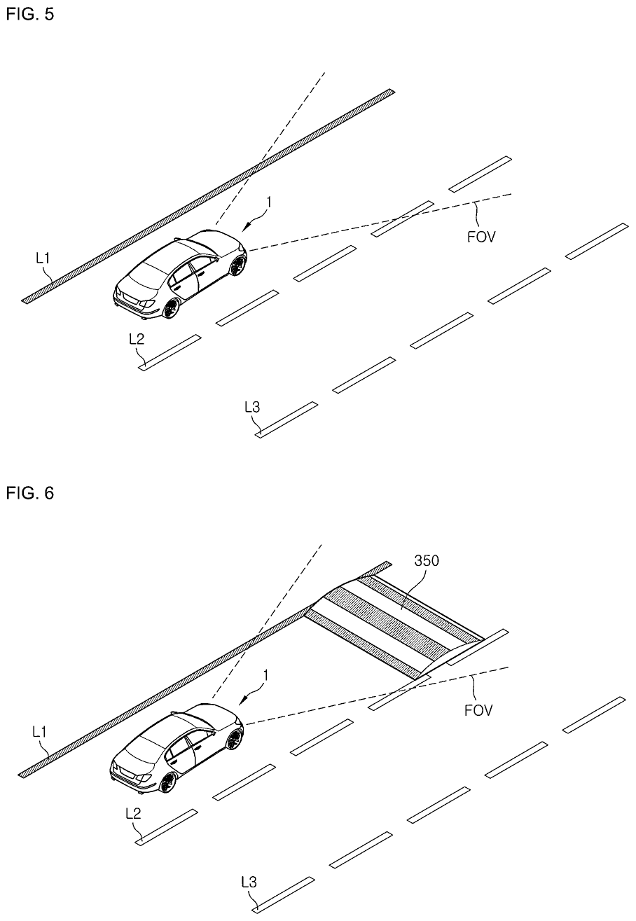

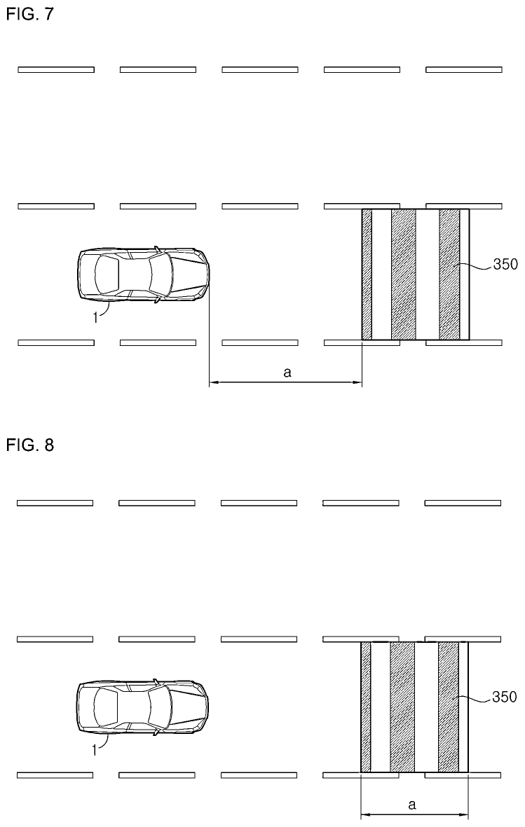

FIG. 3 illustrates function modules of a controller included in the driving assistance apparatus in accordance with one embodiment. FIG. 4 is a diagram embodying a control module illustrated in FIG. 3. FIG. 5 illustrates a field of view of a camera of the vehicle. FIG. 6 illustrates that the vehicle of the disclosed embodiment identifies the speed bump 350. FIG. 7 illustrates a distance from the vehicle to the speed bump 350. FIG. 8 illustrates a width of the speed bump 350.

The controller 140 may functionally include a plurality of modules. Each of the modules may be a hardware module (e.g., an ASIC or FPGA) included in the processor 141 or a software module (e.g., an application program or data) stored in the memory 142.

The controller 140 may include a sensor fusion module 210, a position measurement module 230, a control torque calculation module 220, and a control module 250, as illustrated in FIG. 3.

The sensor fusion module 210 of the controller 140 may fuse image data of the camera 110, radar data of the radar 120, and lidar data of the lidar 130 and output information to the surrounding objects of the vehicle 1.

The sensor fusion module 210 may identify a relative position (angle to the driving direction) and/or classification (e.g., whether an object is another vehicle, a pedestrian, a cyclist, etc.) of the image data. The sensor fusion module 210 may identify a relative position (distance from the vehicle) and/or a relative speed of the radar data. In addition, the sensor fusion module 210 may identify a relative position (distance from the vehicle and/or angle to the driving direction) and/or a relative speed of the lidar data.

The sensor fusion module 210 may match the image data, the radar data, and the lidar data with each other and obtain fusion data based on the matching. For example, the sensor fusion module 210 may identify overlapping portions among the image data, the radar data, and the lidar data based on position information of the image data, position information of the radar data, and position information of the lidar data.

In addition, the sensor fusion module 210 may integrate information of the image data, the radar data, and/or the lidar data. The sensor fusion module 210 may integrate information (e.g., position information and speed information) of the image data obtained from the camera 110, information (e.g., position information and speed information) of the radar data obtained from the radar 120, and information (e.g., position information and speed information) of the lidar data obtained from the lidar 130.

The sensor fusion module 210 may provide the fusion data and information (e.g., information on the classification, position, and speed) on the fusion data to the control torque calculation module 220.

The position measurement module 230 of the controller 140 may obtain map data and position information about the vehicle 1 from the navigation apparatus 10. The position measurement module 230 may identify the position of the vehicle 1 based on the map data and the position information about the vehicle 1. In other words, the controller 140 may identify absolute coordinates of the vehicle 1. The position measurement module 230 may provide the map data and the information on the position of the vehicle 1 to the control torque calculation module 220.

The control torque calculation module 220 of the controller 140 calculates the control torque for the operation of the lane following assist function. The control torque calculation module 220 may calculate the control torque based on the image data, the radar data, the lidar data, or the fusion data thereof transferred from the sensor fusion module and the position information about the vehicle transferred from the position measurement module. The control torque may be a steering torque for controlling steering of the vehicle.

More specifically, the control torque calculation module 220 may calculate a control torque required to perform the lane following assist function using information on lane lines L1, L2, and L3, information on preceding vehicles, information on surrounding vehicles, information on the distance to the speed bump 350, information on obstacles, and the like, identified from speed information about the vehicle input from the behavior sensor, the image data of the camera, the radar data of the radar, the lidar data of the lidar, or the fusion data thereof.

In order to prevent the control torque for performing the lane following assist function from being abnormally calculated when the vehicle passes the speed bump 350, the control module 250 of the controller 140 maintains the control torque calculated before passing the speed bump 350 while the vehicle passes the speed bump 350.

First, the controller 140 checks whether the speed bump 350 exists in front using the image data of the camera, the radar data of the radar, the lidar data of the lidar, or the fusion data thereof. As illustrated in FIG. 5, the camera, the radar, or the lidar mounted on the vehicle may have a field of view (FOV) in front of the vehicle, and as illustrated in FIG. 6, when the speed bump 350 exists in the field of view, the control module 250 may identify the speed bump 350 (251).

When the speed bump 350 is identified, the control module 250 determines a passage time required for the vehicle to pass the speed bump 350 (252). The control module 250 may calculate a distance a to the speed bump 350 in front, as illustrated in FIG. 7, and a width b of the speed bump 350, as illustrated in FIG. 8, using the image data of the camera, the radar data of the radar, the lidar data of the lidar, or the fusion data thereof. In addition, the control module 250 determines the time required for the vehicle to pass the speed bump 350 using the thus calculated information related to the speed bump 350 and the speed of the vehicle received from the behavior sensor.

When the passage time of the speed bump 350 is determined, the control module 250 maintains the control torque for performing the lane following assist function calculated before passing the speed bump 350 during the passage time of the speed bump 350 (253). The control torque calculated before passing the speed bump 350 may be a control torque calculated when the vehicle enters the speed bump 350 within a preset distance or within a preset time. The control module 250 maintains the control torque calculated before passing the speed bump 350 while the vehicle passes the speed bump 350, thereby making it possible to solve the problem in which the control torque may be abnormally calculated due to unstable behavior of the vehicle or misrecognition of the lane line while the vehicle passes the speed bump 350.

The control module 250 transmits the control torque calculated before passing the speed bump 350 to the steering apparatus while the vehicle passes the speed bump 350, thereby allowing the lane following assist function to be performed with the control torque calculated before passing the speed bump 350.

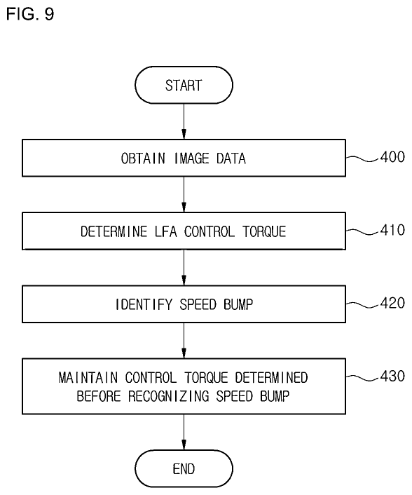

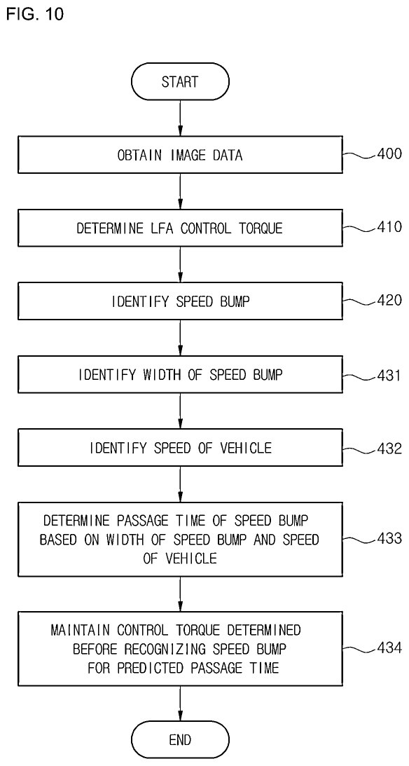

FIGS. 9 and 10 illustrate operations of the driving assistance apparatus in accordance with one embodiment.

Referring to FIG. 9, the controller 140 obtains image data (400) and determines a control torque for performing the lane following assist function (410).

The controller 140 may fuse image data of the camera 110, radar data of the radar 120, and lidar data of the lidar 130 and output information to the surrounding objects of the vehicle 1.

The controller 140 may match the image data, the radar data, and the lidar data with each other and obtain fusion data based on the matching. For example, the controller 140 may identify overlapping portions among the image data, the radar data, and the lidar data based on position information of the image data, position information of the radar data, and position information of the lidar data.

In addition, the controller 140 may integrate information of the image data, the radar data, and/or the lidar data. The controller 140 may integrate information (e.g., position information and speed information) of the image data obtained from the camera 110, information (e.g., position information and speed information) of the radar data obtained from the radar 120, and information (e.g., position information and speed information) of the lidar data obtained from the lidar 130.

The controller 140 calculates a control torque for operation of the lane following assist function. The controller 140 may calculate the control torque based on the image data, the radar data, the lidar data, or the fusion data thereof and position information about the vehicle. The control torque may be a steering torque for controlling steering of the vehicle.

More specifically, the controller 140 may calculate a control torque required to perform the lane following assist function using information on lane lines, information on preceding vehicles, information on surrounding vehicles, information on the distance to the speed bump 350, information on obstacles, and the like, identified from speed information about the vehicle input from the behavior sensor, the image data from the camera, the radar data from the radar, the lidar data from the lidar, or the fusion data thereof.

The controller 140 may identify the speed bump 350 in front of the vehicle (420) and maintain the control torque determined before identifying the speed bump 350 while the vehicle passes the speed bump 350 (430). Referring to FIG. 10 embodying operation 430, the controller 140 identifies a width of the speed bump 350 (431), identifies a speed of the vehicle (432), determines a passage time of the speed bump 350 based on the width of the speed bump 350 and the speed of the vehicle (433), and maintains the control torque determined before identifying the speed bump 350 during the determined passage time (434).

In order to prevent the control torque for performing the lane following assist function from being abnormally calculated when the vehicle passes the speed bump 350, the controller 140 maintains the control torque calculated before passing the speed bump 350 while the vehicle passes the speed bump 350.

First, the controller 140 checks whether the speed bump 350 exists in front using the image data of the camera, the radar data of the radar, the lidar data of the lidar, or the fusion data thereof. As illustrated in FIG. 5, the camera, the radar, or the lidar mounted on the vehicle may have a field of view (FOV) in front of the vehicle, and as illustrated in FIG. 6, when the speed bump 350 exists in the field of view, the controller 140 may identify the speed bump 350.

When the speed bump 350 is identified, the controller 140 determines a passage time required for the vehicle to pass the speed bump 350. The controller 140 may calculate the distance a to the speed bump 350 in front, as illustrated in FIG. 7, and the width b of the speed bump 350, as illustrated in FIG. 8, using the image data of the camera, the radar data of the radar, the lidar data of the lidar, or the fusion data thereof. In addition, the controller 140 determines the time required for the vehicle to pass the speed bump 350 using the thus calculated information related to the speed bump 350 and the speed of the vehicle received from the behavior sensor.

When the passage time of the speed bump 350 is determined, the controller 140 maintains the control torque for performing the lane following assist function calculated before passing the speed bump 350 during the passage time of the speed bump 350. The control torque calculated before passing the speed bump 350 may be a control torque calculated when the vehicle enters the speed bump 350 within a preset distance or within a preset time. The controller 140 maintains the control torque calculated before passing the speed bump 350 while the vehicle passes the speed bump 350, thereby making it possible to solve the problem in which the control torque may be abnormally calculated due to unstable behavior of the vehicle or misrecognition of the lane line while the vehicle passes the speed bump 350.

The controller 140 transmits the control torque calculated before passing the speed bump 350 to the steering apparatus while the vehicle passes the speed bump 350, thereby allowing the lane following assist function to be performed with the control torque calculated before passing the speed bump 350.

As is apparent from the above description, in accordance with one aspect of the present disclosure, it is possible to secure behavioral stability of a vehicle in which a lane following control function is operating by maintaining a control torque of the lane following control function when the vehicle passes a speed bump.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. An apparatus for driving assistance, the apparatus comprising:
a camera mounted on a vehicle to have a field of view around the vehicle and configured to obtain image data; and
a controller configured to:
determine a control torque for performing a lane following assist function based on processing the image data and behavior data obtained from a behavior sensor provided in the vehicle,
identify a speed bump in a driving lane of the vehicle based on the processing of the image data; and
maintain the control torque determined before passing the speed bump while the vehicle passes the speed bump.

2. The apparatus according to claim 1, wherein the behavior data includes data on at least one of a steering angle, a steering speed, a yaw rate, or a wheel speed.

3. The apparatus according to claim 1, wherein the controller is configured to identify a distance to the speed bump based on the processing of the image data and the behavior data.

4. The apparatus according to claim 1, wherein the controller is configured to identify a time required to pass the speed bump based on the processing of the image data and the behavior data.

5. The apparatus according to claim 1, wherein the controller is configured to:
identify a width of the speed bump based on the processing of the image data;
identify a speed of the vehicle based on the processing of the behavior data; and
determine a time required to pass the speed bump based on the identified width of the speed bump and the identified speed of the vehicle.

6. The apparatus according to claim 4, wherein the controller is configured to maintain the control torque determined before passing the speed bump for the determined time.

7. The apparatus according to claim 1, wherein the controller is configured to transmit the control torque determined before passing the speed bump to a steering apparatus of the vehicle so that steering control according to the control torque determined before passing the speed bump is performed while the vehicle passes the speed bump.

8. A method for driving assistance, the method comprising:
obtaining image data by a camera having a field of view around a vehicle;
determining a control torque for performing a lane following assist function based on processing the image data and behavior data obtained from a behavior sensor provided in the vehicle;
identifying a speed bump in a driving lane of the vehicle based on the processing of the image data; and
maintaining the control torque determined before passing the speed bump while the vehicle passes the speed bump.

9. The method according to claim 8, wherein the behavior data includes data on at least one of a steering angle, a steering speed, a yaw rate, or a wheel speed.

10. The method according to claim 8, further comprising identifying a distance to the speed bump based on the processing of the image data and the behavior data.

11. The method according to claim 8, wherein the maintaining of the control torque determined before passing the speed bump while the vehicle passes the speed bump comprises determining a time required to pass the speed bump based on the processing of the image data and the behavior data.

12. The method according to claim 8, wherein the maintaining of the control torque determined before passing the speed bump while the vehicle passes the speed bump comprises:
identifying a width of the speed bump based on the processing of the image data;
identifying a speed of the vehicle based on the processing of the behavior data; and
determining a time required to pass the speed bump based on the identified width of the speed bump and the identified speed of the vehicle.

13. The method according to claim 11, wherein the maintaining of the control torque determined before passing the speed bump while the vehicle passes the speed bump comprises maintaining the control torque determined before passing the speed bump for the determined time.

14. The method according to claim 8, further comprising transmitting the control torque determined before passing the speed bump to a steering apparatus of the vehicle so that steering control according to the control torque determined before passing the speed bump is performed while the vehicle passes the speed bump.

15. A vehicle comprising:
a camera having a field of view around the vehicle and configured to obtain image data;
a behavior sensor configured to obtain behavior data of the vehicle; and
a controller configured to:
determine a control torque for performing a lane following assist function based on processing the image data and the behavior data,
identify a speed bump in a driving lane of the vehicle based on the processing of the image data; and
maintain the control torque determined before passing the speed bump while the vehicle passes the speed bump.

16. The vehicle according to claim 15, wherein the controller is configured to determine a distance to the speed bump based on the processing of the image data and the behavior data.

17. The vehicle according to claim 15, wherein the controller is configured to determine a time required to pass the speed bump based on the processing of the image data and the behavior data.

18. The vehicle according to claim 15, wherein the controller is configured to:
identify a width of the speed bump based on the processing of the image data;
identify a speed of the vehicle based on the processing of the behavior data; and
determine a time required to pass the speed bump based on the identified width of the speed bump and the identified speed of the vehicle.

19. The vehicle according to claim 17, wherein the controller is configured to maintain the control torque determined before passing the speed bump for the determined time.

20. The vehicle according to claim 15, wherein the controller is configured to control a steering apparatus of the vehicle so that steering control according to the control torque determined before passing the speed bump is performed while the vehicle passes the speed bump.
